(19) United States
(12) Patent Application Publication
(10) Pub. No.: US 2022/0327379 A1
(43) Pub. Date: Oct. 13, 2022

(54) NEURAL NETWORK LEARNING APPARATUS, NEURAL NETWORK LEARNING METHOD, AND PROGRAM

(71) Applicant: NIPPON TELEGRAPH AND TELEPHONE CORPORATION, Tokyo (JP)

(72) Inventors: Yuma KOIZUMI, Tokyo (JP); Shin MURATA, Tokyo (JP); Ryotaro SATO, Tokyo (JP)

(73) Assignee: NIPPON TELEGRAPH AND TELEPHONE CORPORATION, Tokyo (JP)

(21) Appl. No.: 17/639,330

(22) PCT Filed: Sep. 2, 2019
(86) PCT No.: PCT/JP2019/034377

§ 371 Date: Feb. 28, 2022

(51) Int. Cl. G06N 3/08

(52) U.S. Cl. CPC G06N 3/08

(57) ABSTRACT

There is provided a neural network learning technique for learning a parameter of a probability density function representing the distribution of data with high accuracy using an autoencoder. A neural network learning apparatus, wherein θ is a parameter of a probability density function q_{θ}(x) representing distribution of data x, and M_{θ} is a neural network that is an autoencoder that learns the parameter θ, the neural network learning apparatus including: a neural network calculation unit that calculates an output value M_{θ}(xₙ) of the neural network from learning data xₙ using the parameter θ for n=1, . . . , N; a cost function calculation unit that calculates an evaluation value of a cost function L using the learning data xₙ (1≤n≤N) and the output value M_{θ}(xₙ) (1≤n≤N); and a parameter update unit that updates the parameter θ using the evaluation value, wherein the cost function L is defined by an expression using a normalization constant Z_{θ} of a Boltzmann distribution defined based on a reconstruction error E_{θ}(x)=∥x−M_{θ}(x)∥₂² of the data x.

### TECHNICAL FIELD

The present invention relates to a technique for learning a probability density function representing the distribution of data.

### BACKGROUND ART

In unsupervised anomaly detection problems, only normal data is used to learn a probability density function representing the distribution of data (called a normal model), and when the abnormality degree for observed data that is calculated using the normal model has exceeded a predetermined threshold, the observed data is determined to be abnormal (see Non-Patent Literature 1). Therefore, it is required to accurately learn the normal model in anomaly detection problems.

In recent years, many methods for learning a normal model using deep learning have been proposed (see Non-Patent Literature 2). For example, there is a method using an autoencoder (AE) as the most well-known one among them. There is also a method using a variational AE (VAE) disclosed in Non-Patent Literature 3.

### CITATION LIST

### Non-Patent Literature

Non-Patent Literature 1: V. Chandola, A. Banerjee, and V. Kumar, “Anomaly detection: A survey,” ACM Computing Surveys, 2009.

Non-Patent Literature 2: R. Chalapathy and S. Chawla, “Deep Learning for Anomaly Detection: A Survey,” arXiv preprint, arXiv:1901.03407, 2019.

Non-Patent Literature 3: D. P. Kingma, and M. Welling, “Auto-Encoding Variational Bayes,” in Proc. of International Conference on Learning Representations (ICLR), 2013.

### SUMMARY OF THE INVENTION

### Technical Problem

However, the method using an autoencoder and the method using a variational AE both have a problem that the accuracy of estimating the normal model is not high, that is, a problem that a parameter of a probability density function representing the distribution of data cannot be learned with high accuracy.

Therefore, an object of the present invention is to provide a neural network learning technique for learning a parameter of a probability density function representing the distribution of data with high accuracy using an autoencoder.

### Means for Solving the Problem

An aspect of the present invention is a neural network learning apparatus, wherein θ is a parameter of a probability density function q_{θ}(x) representing distribution of data x, and M_{θ} is a neural network that is an autoencoder that learns the parameter θ, the neural network learning apparatus including: a neural network calculation unit that calculates an output value M_{θ}(xₙ) of the neural network from learning data xₙ using the parameter θ for n=1, . . ., N; a cost function calculation unit that calculates an evaluation value of a cost function L using the learning data xₙ (1≤n≤N) and the output value M_{θ}(xₙ) (1≤n≤N); and a parameter update unit that updates the parameter θ using the evaluation value, wherein Z_{θ} is a normalization constant of a Boltzmann distribution defined based on a reconstruction error E_{θ}(x)=∥x−M_{θ}(x)∥₂² of the data x, and the cost function L is defined by the following expression:

$$L = {L}_{θ}^{AE} + ln {Z}_{θ} {L}_{θ}^{AE} = \frac{1}{N} {\sum }_{n = 1}^{N} {E}_{θ} ( {x}_{n} ) \qquad [ Math . 1 ]$$

### Effects of the Invention

According to the present invention, it is possible to learn a parameter of a probability density function representing the distribution of data with high accuracy using an autoencoder.

### BRIEF DESCRIPTION OF DRAWINGS

FIG. 1 is a block diagram showing an example configuration of a neural network learning apparatus 100.

FIG. 2 is a flowchart showing an example operation of the neural network learning apparatus 100.

FIG. 3 is a diagram showing an example functional configuration of a computer that implements each apparatus in an embodiment of the present invention.

### DESCRIPTION OF EMBODIMENTS

Hereinafter, an embodiment of the present invention will be described in detail. Note that the component units having the same function are given the same reference numeral, and duplicate explanations will be omitted.

### Notation

_ (underscore) represents a subscript. For example, x^{y_z} means that y_{z} is a superscript for x, and x_{y_z} means that y_{z} is a subscript for x.

Further, superscripts “^” and “˜” such as ^x and ˜x for a certain character x should formally be written directly above “x”, but they are written as ^x and ˜x due to restrictions on the description and notation in the specification.

### TECHNICAL BACKGROUND

### Unsupervised Anomaly Detection

Unsupervised anomaly detection is a technique for learning a normal model using N pieces of normal data {xₙ}ₙ₌₁^{N} (xₙ∈R^{D} and D is a predetermined constant) generated from the true distribution p(x) of data x as learning data (this process is called the learning process), and determining whether a newly obtained sample (i.e., observed data) is normal or abnormal using the normal model (this process is called the inference process). Here, data to be handled may be anything, for example, it may be feature amounts extracted from audio data, or it may be images or sensor values acquired using other sensors.

Unsupervised anomaly detection will be described below in detail. In unsupervised anomaly detection, the true distribution p(x) is first learned as a normal model. Here, the normal model is represented as a probability density function q_{θ}(x) representing the distribution of data x, and specifically, the parameter θ will be learned.

Then, for observed data x, an abnormality degree A_{θ}(x) is defined as negative log-likelihood using the normal model as shown in Expression (1):

[Math. 2]

A_{θ}(x)=−ln q_{θ}(x) (1)

If the abnormality degree A_{θ}(x) for the observed data x has exceeded a predetermined threshold, the observed data x is determined to be abnormal, or otherwise, the observed data x is determined to be normal.

In this framework, it is necessary to learn the parameter θ so that the two distributions p(x) and q_{θ}(x) are close to each other. Distance measures for measuring the closeness of the two distributions p(x) and q_{θ}(x) include, for example, the Kullback-Leibler divergence (KLD) of the following expression:

[Math. 3]

L_{θ}^{KL}=−∫p(x)ln q_{θ}(x)dx+C (2)

Here, C=∫p(x)ln p(x)dx.

In this case, KLD minimization is performed in which the parameter θ is learned using the Kullback-Leibler divergence as the cost function. However, since C is a value that does not depend on θ, it is often omitted in the minimization.

When an autoencoder is used for learning the normal model, the abnormality degree is defined as a reconstruction error E_{θ}(x) for the data x as shown in the following expression:

[Math. 4]

E_{θ}(x)=∥x−M_{θ}(x)∥₂² (3)

Here, M_{θ} is an autoencoder that learns the parameter θ, and ∥⋅81 ₂ represents the L₂ norm.

Note that in the narrow sense, the autoencoder means that the encoder and the decoder are symmetrical networks, but this is not necessary here.

The definition of the abnormality degree described above is equivalent to defining it as negative log-likelihood that is calculated by ignoring, from the Boltzmann distribution:

$$\begin{matrix}[ Math . 5 ] & \\ {q}_{θ} ( x ) = \frac{1}{{Z}_{θ}} exp ( - {E}_{θ} ( x ) ) & ( 4 )\end{matrix}$$

the normalization constant:

[Math. 6]

Z_{θ}=∫exp(−E_{θ}(x))dx (5)

(see Reference Non-Patent Literature 1). As can be seen from Expression (5), the normalization constant Z_{θ} of the Boltzmann distribution is a value that does not depend on x, so there is no problem even when the function E_{θ}(x) in Expression (3) is used as the abnormality degree in the inference process.

### (Reference Non-Patent Literature 1: S. Zhai, Y. Cheng, W. Lu, and Z. M. Zhang, “Deep Structured Energy Based Models for Anomaly Detection,”, in Proc. of International Conference on Machine Learning (ICML), 2016.)

When an autoencoder is used for learning the normal model, a cost function L_{θ}^{AE} defined by the following expression is used for learning the parameter θ instead of the cost function L_{θ}^{KL} in Expression (2):

$$\begin{matrix}[ Math . 7 ] & \\ {L}_{θ}^{AE} = \frac{1}{N} {\sum }_{n = 1}^{N} {E}_{θ} ( {x}_{n} ) & ( 6 )\end{matrix}$$

That is, the parameter θ is learned so that the average reconstruction error in Expression (6) may be minimized. The reason to perform learning using Expression (6) is due to the fact that the normalization constant Z_{θ} of the Boltzmann distribution cannot be determined analytically. In the learning using the cost function L_{θ}^{AE} in Expression (6), the autoencoder learns to reconstruct any data, so there is a possibility that not only normal data but also abnormal data are reconstructed. That is, the learning using the cost function L_{θ}^{AE} has a problem that the abnormality degree for the abnormal data does not increase.

Therefore, an approach of learning the parameter θ in consideration of the normalization constant Z_{θ} is conceivable as in learning using the restricted Boltzmann machine, but a new problem arises that the computational cost increases because sampling is used in learning using the restricted Boltzmann machine.

Further, since the method using a variational AE also requires sampling in both the learning process and the inference process, there remains the problem that the computational cost is still high (see Reference Non-Patent Literature 2).

(Reference Non-Patent Literature 2: J. An and S. Cho, “Variational Autoencoder based Anomaly Detection using Reconstruction Probability,” Technical Report. SNU Data Mining Center, pp. 1-18, 2015.)

<<Cost Function used in Embodiment of the Present Application>>

The embodiment of the present application uses a method of learning the parameter θ without performing additional sampling. Specifically,

$$\begin{matrix}[ Math . 8 ] & \\ {L}_{θ}^{KL} ∝ - \int p ( x ) ln \{ \frac{1}{{Z}_{θ}} exp ( - {E}_{θ} ( x ) ) \} dx & ( 7 )\end{matrix}$$

is used as the cost function to learn the parameter θ.

First, Expression (7) is transformed as follows:

[Math. 9]

L_{θ}^{KL}∝∫p(x)E_{θ}(x)dx+∫p(x)ln Z_{θ}dx (8)

Here, the first term on the right side is the expectation of the reconstruction error, which can be approximated by the function L_{θ}^{AE}. Further, since the normalization constant Z_{θ} that appears in the second term on the right side is a value that does not depend on x, it can be treated as a constant in the integral calculation of the second term, and since ∫p(x)dx=1, it can be seen that the second term is ln Zθ. Therefore, for KLD minimization, it is sufficient to minimize the following cost function L:

[Math. 10]

L=L_{θ}^{AE}+ln Z_{θ} (9)

Here, using p(x)p(x)⁻¹=1, Expression (5), which is the definition expression of the normalization constant Zθ, is transformed as follows:

$$\begin{matrix}[ Math . 11 ] & \\ {Z}_{θ} = \int p ( x ) \frac{1}{p ( x )} exp ( - {E}_{θ} ( x ) ) dx & ( 10 )\end{matrix}$$

Then, by replacing ∫p(x)dx with the arithmetic mean of the learning data, the normalization constant Zθ can be approximated as follows:

$$\begin{matrix}[ Math . 12 ] & \\ {Z}_{θ} \approx \frac{1}{N} {\sum }_{n = 1}^{N} \frac{1}{p ( {x}_{n} )} exp ( - {E}_{θ} ( {x}_{n} ) ) & ( 11 )\end{matrix}$$

Since Expression (11) includes the reciprocal of the true distribution p(x), the normalization constant Zθ cannot be determined analytically as it is. Therefore, the true distribution p(x) is approximated using kernel density estimation:

$$\begin{matrix}[ Math . 13 ] & \\ K ( {x}_{n} ) = \frac{1}{N} {\sum }_{j = 1}^{N} \frac{1}{{( 2 {πσ}^{2} )}^{D / 2}} exp ( \frac{{‖ {x}_{n} - {x}_{j} ‖}_{2}^{2}}{2 {σ}^{2}} ) & ( 12 )\end{matrix}$$

Here, σ is a bandwidth parameter, and may preferably be set to, for example, about 0.2.

Then, the following cost function L is obtained from Expressions (9) and (11):

$$\begin{matrix}[ Math . 14 ] & \\ L = {L}_{θ}^{A E} + ln [ \frac{1}{N} {\sum }_{n = 1}^{N} w ( {x}_{n} ) exp ( - {E}_{θ} ( {x}_{n} ) ) ] & ( 13 )\end{matrix}$$

$$w ( {x}_{n} ) = {( K ( {x}_{n} ) + ε )}^{- 1} \qquad ( 14 )$$

To summarize the above, it can be said that the embodiment of the present application is a method of learning the parameter θ so as to minimize KLD, and is a method of learning the probability density function in which the cost function is Expression (13), which is obtained by approximating the reciprocal of the true distribution p(x) included in the normalization constant Zθ, which has caused the difficulty in calculation, using kernel density estimation.

### Example

In learning the parameter θ using the cost function described above, for example, it is sufficient to perform the following procedure:

(1) N₀ pieces of learning data (N₀ is an integer of 1 or more), which are normal data, are prepared in advance.
(2) A mini-batch composed of, for example, 1,000 samples is generated from the N₀ pieces of learning data.
(3) An evaluation value of the cost function L in Expression (13) is calculated using the mini-batch generated in (2).
(4) The parameter θ is updated using the evaluation value, which is the calculation result of (3). For example, it is preferable to determine the gradient of the evaluation value with respect to the parameter θ, and update the parameter θ using a gradient method.
(5) If the predetermined end condition is satisfied, the parameter θ at that time is output and the processing is terminated, or otherwise the processing returns to (2).

Note that it is sufficient to set the bandwidth parameter σ to about σ=1.0.Further, as the end condition, for example, a condition of whether or not the update process is repeated 5,000 times can be used.

<<Summary>>

(1) When the parameter θ is learned, the Kullback-Leibler divergence between the true distribution p(x) and the empirical distribution q_{θ}(x) is used as the cost function instead of the average reconstruction error. As a result, the normalization constant Z_{θ} of the empirical distribution q_{θ}(x) is incorporated into the cost function, and the parameter θ can be learned with high accuracy.
(2) Further, kernel density estimation is used so that the normalization constant Z_{θ} can be calculated.

### FIRST EMBODIMENT

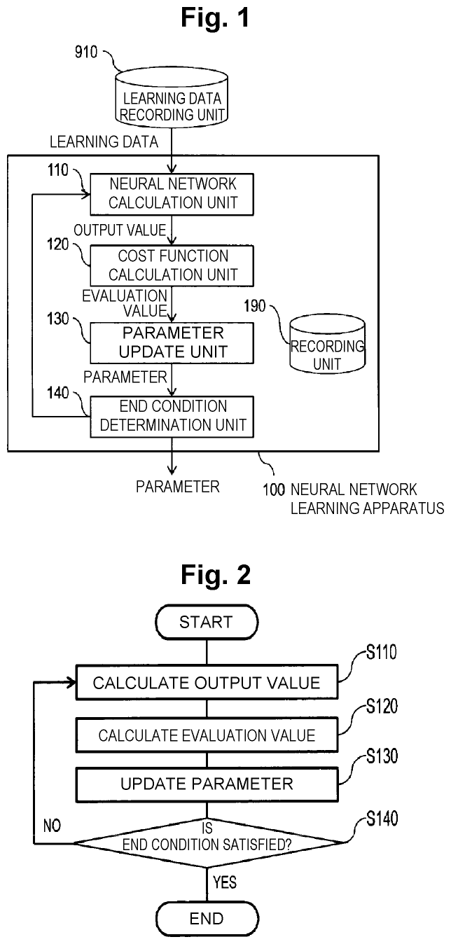

Hereinafter, a neural network learning apparatus 100 will be described with reference to FIGS. 1 and 2. FIG. 1 is a block diagram showing a configuration of the neural network learning apparatus 100. FIG. 2 is a flowchart showing operation of the neural network learning apparatus 100. As shown in FIG. 1, the neural network learning apparatus 100 includes a neural network calculation unit 110, a cost function calculation unit 120, a parameter update unit 130, an end condition determination unit 140, and a recording unit 190. The recording unit 190 is a component unit that appropriately records information required for processing of the neural network learning apparatus 100. For example, the parameter θ of the probability density function q_{θ}(x) representing the distribution of data x to be learned is recorded.

The neural network learning apparatus 100 is connected to a learning data recording unit 910. N₀ pieces of learning data (N₀ is an integer of 1 or more) that are collected in advance are recorded in the learning data recording unit 910. Here, the learning data x is x ∈R^{D} (where D is an integer of 1 or more), that is, a D-dimensional real number vector.

Various parameters (e.g., an initial value of the parameter θ) used in each component unit of the neural network learning apparatus 100 may be input externally in the same manner as the N₀ pieces of learning data, or may be set in advance in each component unit. Further, the N₀ pieces of learning data may be recorded in the recording unit 190 instead of the external learning data recording unit 910.

The neural network calculation unit 110, which is one of the component units of the neural network learning apparatus 100, is configured using the neural network M_{θ}, which is an autoencoder that learns the parameter θ.

The operation of the neural network learning apparatus 100 will be described in accordance with FIG. 2.

In S110, the neural network calculation unit 110 generates a mini-batch {xₙ}ₙ₌₁^{N} (xₙ∈R^{D}) from the N₀ pieces of learning data, and calculates, for n=1, . . . , N, the output value M_{θ}(xₙ) of the neural network from the learning data xₙ using the parameter θ.

In S120, the cost function calculation unit 120 calculates the evaluation value of the cost function L using the learning data xₙ (1≤n≤N) used in the calculation in S110 and the output value M_{θ}(xₙ) (1≤n≤N) calculated in S110. For example, E_{θ}(x)=∥x−M_{θ}(x)∥₂² is the reconstruction error of the data x, q_{θ}(x)=1/Z_{θ} exp(−E_{θ}(x)) is the Boltzmann distribution defined based on the reconstruction error E_{θ}(x) of the data x (where Z_{θ} is a normalization constant), and the function defined by the following expression can be used as the cost function L:

$$\begin{matrix}[ Math . 15 ] & \\ L = {L}_{θ}^{AE} + ln {Z}_{θ} & \end{matrix}$$

$${L}_{θ}^{AE} = \frac{1}{N} {\sum }_{n = 1}^{N} {E}_{θ} ( {x}_{n} )$$

Further, as the normalization constant Z_{θ}, for example, one calculated by the following expression can be used:

$$\begin{matrix}[ Math . 16 ] & \\ {Z}_{θ} \frac{1}{N} {\sum }_{n = 1}^{N} w ( {x}_{n} ) exp ( - {E}_{θ} ( {x}_{n} ) ) & \end{matrix}$$

$$w ( {x}_{n} ) = {( K ( {x}_{n} ) + ε )}^{- 1}$$

$$K ( {x}_{n} ) \frac{1}{N} {\sum }_{j = 1}^{N} \frac{1}{{( 2 π {σ}^{2} )}^{D / 2}} exp ( - \frac{{‖ {x}_{n} - {x}_{j} ‖}_{2}^{2}}{2 {σ}^{2}} )$$

(where, ε, σ, and D are predetermined constants).

In S130, the parameter update unit 130 updates the parameter θ using the evaluation value calculated in S120. A gradient method may preferably be used to update the parameter θ. Note that as the gradient method, any method can be used, such as a stochastic gradient method and an error backpropagation method.

In S140, the end condition determination unit 140 determines the end condition set in advance as the end condition for parameter update, and outputs the parameter θ updated in S130 when the end condition is satisfied, or repeats the processes of S110 to S140 when the end condition is not satisfied. As the end condition, for example, a condition can be employed as to whether or not the number of execution times of the processes of S110 to S140 has reached a predetermined number of times. For example, it is sufficient to set the predetermined number of times to 5,000 times.

According to the invention of this embodiment, it is possible to learn a parameter of a probability density function representing the distribution of data with high accuracy using an autoencoder.

### SUPPLEMENTARY NOTES

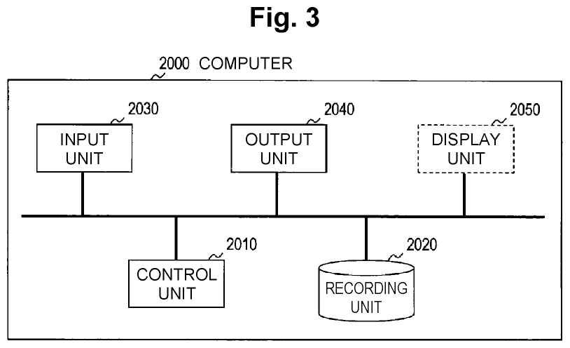

FIG. 3 is a diagram showing an example functional configuration of a computer that implements each apparatus described above. The processing in each apparatus described above can be carried out by causing the recording unit 2020 to load a program for making the computer function as each apparatus described above, and causing the control unit 2010, the input unit 2030, the output unit 2040, and the like to operate.

The apparatus of the present invention has, for example, as a single hardware entity, an input unit to which a keyboard or the like can be connected, an output unit to which a liquid crystal display or the like can be connected, a communication unit to which a communication device (e.g., a communication cable) enabling communication with the outside of the hardware entity can be connected, a CPU (central processing unit, which may be equipped with a cache memory, registers, etc.), a RAM and a ROM that are a memory, an external storage device that is a hard disk, and a bus that connects the input unit, the output unit, the communication unit, the CPU, the RAM, the ROM, and the external storage device so that data can be exchanged therebetween. Further, as necessary, the hardware entity may be provided with a device (drive) or the like capable of reading from and writing to a recording medium such as a CD-ROM. Physical entities equipped with such hardware resources include a general-purpose computer and the like.

A program required to implement the functions described above and data required for processing of this program are stored in the external storage device of the hardware entity (this is not limited to the external storage device, for example, the program may be stored in a ROM, which is a read-only storage device). Further, data obtained by the processing of these programs and the like are appropriately stored in the RAM, the external storage device, or the like.

In the hardware entity, each program stored in the external storage device (or the ROM, etc.) and data required for processing of this program are loaded onto the memory as necessary, and are interpretively executed and processed by the CPU as appropriate. As a result, the CPU implements a predetermined function (each constituent component that is represented above as, . . . unit, . . . means, etc.).

The present invention is not limited to the embodiment described above, and can be appropriately modified within the range not departing from the spirit of the present invention. Further, the processes described in the above embodiment may not only be executed in chronological order according to the described order, but also be executed in parallel or individually depending on the processing capacity of the device that executes the processes or as necessary.

As previously described, when the processing functions in the hardware entity (the apparatus of the present invention) described in the above embodiment are implemented by a computer, the processing content of the functions that the hardware entity should have is written by a program. Then, by executing this program on the computer, the processing functions in the above hardware entity are implemented on the computer.

The program in which the processing content is written can be recorded on a computer-readable recording medium. The computer-readable recording medium may be anything such as a magnetic recording device, an optical disc, a photomagnetic recording medium, a semiconductor memory, and the like. Specifically, for example, it is possible to use a hard disk device, a flexible disk, a magnetic tape, etc. as the magnetic recording device, a DVD (digital versatile disc), a DVD-RAM (random access memory), a CD-ROM (compact disc read only memory), a CD-R (recordable)/RW (rewritable), etc. as the optical disc, an MO (Magneto-Optical disc), etc. as the photomagnetic recording medium, and an EEP-ROM (electronically erasable and programmable-read only memory), etc. as the semiconductor memory.

Further, this program is distributed by, for example, selling, transferring, or lending a portable recording medium such as a DVD or CD-ROM on which the program is recorded. Further, a configuration is possible in which this program is distributed by storing in advance this program in a storage device of a server computer, and transferring the program from the server computer to another computer via a network.

For example, a computer that executes such a program first temporarily stores the program recorded on the portable recording medium or the program transferred from the server computer in its own storage device. Then, when executing the processing, this computer reads the program stored in its own storage device, and executes the processing according to the read program. Further, as another execution form of this program, a computer may read the program directly from the portable recording medium and execute the process according to the program, and furthermore, each time a program is transferred from the server computer to this computer, the process according to the received program may be executed sequentially. Further, a configuration is possible in which the above-described processing is executed by a so-called ASP (application service provider) type service that implements the processing functions only by an instruction to execute the program and acquisition of the result, rather than transferring the program from the server computer to this computer. Note that the program in this form shall include information used for processing by an electronic computer and equivalent to the program (such as data that is not a direct command to the computer but has a property of defining the processing of the computer).

Further, in this form, the hardware entity is configured by executing a predetermined program on the computer, but at least a part of these processing contents may be implemented in hardware.

1. A neural network learning apparatus, wherein θ is a parameter of a probability density function q_{θ}(x) representing distribution of data x, and M_{θ} is a neural network that is an autoencoder that learns the parameter θ,
the neural network learning apparatus comprising a processor configured to execute a method comprising:
calculating an output value M_{θ}(xₙ) of the neural network from learning data xₙ using the parameter θ for n=1, . . . , N;
calculating an evaluation value of a cost function L using the learning data xₙ (1≤n≤N) and the output value M_{θ}(xₙ) (1≤n≤N); and
updating the parameter θ using the evaluation value,
wherein Z_{θ} is a normalization constant of a Boltzmann distribution defined based on a reconstruction error E_{θ}(x)=∥x−M_{θ}(x)∥₂² of the data x, and the cost function L is defined by the following expression:
$$L = {L}_{θ}^{AE} + ln {Z}_{θ}$$
$${L}_{θ}^{AE} = \frac{1}{N} {\sum }_{n = 1}^{N} {E}_{θ} ( {x}_{n} ) .$$

2. The neural network learning apparatus according to claim 1, wherein the normalization constant Z_{θ} is calculated by the following expression:
$${Z}_{θ} \frac{1}{N} {\sum }_{n = 1}^{N} w ( {x}_{n} ) exp ( - {E}_{θ} ( {x}_{n} ) )$$
$$w ( {x}_{n} ) = {( K ( {x}_{n} ) + ε )}^{- 1}$$
$$K ( {x}_{n} ) \frac{1}{N} {\sum }_{j = 1}^{N} \frac{1}{{( 2 π {σ}^{2} )}^{D / 2}} exp ( - \frac{{‖ {x}_{n} - {x}_{j} ‖}_{2}^{2}}{2 {σ}^{2}} )$$
(where ε, σ, and D are predetermined constants).

3. A computer-implemented method for learning a neural network, wherein
θ is a parameter of a probability density function q_{θ}(x) representing distribution of data x, and M_{θ} is a neural network that is an autoencoder that learns the parameter θ,
the method comprising:
calculating an output value M_{θ}(xₙ) of the neural network from learning data xₙ using the parameter θ for n=1, . . . , N;
calculating an evaluation value of a cost function L using the learning data xₙ (1≤n≤N) and the output value M_{θ}(xₙ) (1≤n≤N); and
updating the parameter θ using the evaluation value,
wherein Z_{θ} is a normalization constant of a Boltzmann distribution defined based on a reconstruction error E_{θ}(x)−∥x−M_{θ}(x)∥₂² of the data x, and
the cost function L is defined by the following expression:
$$L = {L}_{θ}^{AE} + ln {Z}_{θ}$$
$${L}_{θ}^{AE} = \frac{1}{N} {\sum }_{n = 1}^{N} {E}_{θ} ( {x}_{n} ) .$$

4. A computer-readable non-transitory recording medium storing computer-executable program instructions that when executed by a processor for causing cause a computer to execute a method,
wherein
θ is a parameter of a probability density function q_{θ}(x) representing distribution of data x, and M_{θ} is a neural network that is an autoencoder that learns the parameter θ,
the computer-executable program instructions when executed by the processor cause the computer to execute the method comprising:
calculating an output value M_{θ}(xₙ) of the neural network from learning data xₙ using the parameter θ for n=1, . . . , N;
calculating an evaluation value of a cost function L using the learning data xₙ (1≤n≤N) and the output value M_{θ}(xₙ) (1≤n≤N); and
updating the parameter θ using the evaluation value,
wherein Z_{θ} is a normalization constant of a Boltzmann distribution defined based on a reconstruction error E_{θ}(x)=∥x−M_{θ}(x)∥₂² of the data x, and
the cost function L is defined by the following expression:
$$L = {L}_{θ}^{A E} + ln {Z}_{θ}$$
$${L}_{θ}^{A E} = \frac{1}{N} {\sum }_{n = 1}^{N} {E}_{θ} ( {x}_{n} ) .$$

5. The neural network learning apparatus according to claim 1, wherein the cost function L is based on a Kulback-Leiber divergence between a true distribution of the data x and an empirical distribution of the data x.

6. The computer-implemented method according to claim 3,
wherein the normalization constant Z_{θ} is calculated by the following expression:
$${Z}_{θ} \frac{1}{N} {\sum }_{n = 1}^{N} w ( {x}_{n} ) exp ( - {E}_{θ} ( {x}_{n} ) )$$
$$w ( {x}_{n} ) = {( K ( {x}_{n} ) + ε )}^{- 1}$$
$$K ( {x}_{n} ) \frac{1}{N} {\sum }_{j = 1}^{N} \frac{1}{{( 2 π {σ}^{2} )}^{D / 2}} exp ( - \frac{{‖ {x}_{n} - {x}_{j} ‖}_{2}^{2}}{2 {σ}^{2}} )$$
(where ε, σ, and D are predetermined constants).

7. The computer-implemented method according to claim 3, wherein
the cost function L is based on a Kulback-Leiber divergence between a true distribution of the data x and an empirical distribution of the data x.

8. The computer-readable non-transitory recording medium according to claim 4,
wherein the normalization constant Z_{θ} is calculated by the following expression:
$${Z}_{θ} \frac{1}{N} {\sum }_{n = 1}^{N} w ( {x}_{n} ) exp ( - {E}_{θ} ( {x}_{n} ) )$$
$$w ( {x}_{n} ) = {( K ( {x}_{n} ) + ε )}^{- 1}$$
$$K ( {x}_{n} ) \frac{1}{N} {\sum }_{j = 1}^{N} \frac{1}{{( 2 π {σ}^{2} )}^{D / 2}} exp ( - \frac{{‖ {x}_{n} - {x}_{j} ‖}_{2}^{2}}{2 {σ}^{2}} )$$
(where ε, σ, and D are predetermined constants).

9. The computer-readable non-transitory recording medium according to claim 4, wherein
the cost function L is based on a Kulback-Leiber divergence between a true distribution of the data x and an empirical distribution of the data x.
